(19) United States
(12) Patent Application Publication
(10) Pub. No.: US 2026/0244544 A1
(43) Pub. Date: Aug. 20, 2026

(54) FAULT MANAGEMENT IN A COMMUNICATION SYSTEM

(71) Applicant: Afiniti AI Limited, Dublin (IE)

(72) Inventors: Syed Laraib IMTIAZ, Karachi (PK); Sabih UR-REHMAN, Karachi (PK); Iqra JAVED, Lahore (PK); Umer ARSHAD, Lahore (PK)

(73) Assignee: Afiniti AI Limited, Dublin (IE)

(21) Appl. No.: 18/876,743

(22) PCT Filed: Jun. 21, 2023
(86) PCT No.: PCT/US2023/025855

§ 371 Date: Dec. 19, 2024

Related U.S. Application Data
(60) Provisional application No. 63/354,539, filed on Jun. 22, 2022.

(51) Int. Cl. G06F 11/20

(52) U.S. Cl. CPC G06F 11/2041; G06F 2201/81

(57) ABSTRACT

A performed by a first arbiter running on a first node of a communication system, the communication system further comprising a second node and a second arbiter running on the second node. The process includes: transmitting to the second arbiter an are you active message; receiving a response message transmitted by the second arbiter, the response message being responsive to the are you active message; and, after receiving the response, determining the first node to be a standby node.

### TECHNICAL FIELD

Disclosed are embodiments related to fault management in a communication system.

### BACKGROUND

An example of a communication system is a contact center system (a.k.a., call center system). A contact center system may employ a pairing node that functions to assign contacts (a.k.a., calls) to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

### SUMMARY

Certain challenges presently exist. For instance, it is advantageous for a communication system, such as, for example, a contact center system, to achieve high availability. That is, it is important that the system be able to provide continuous, uninterrupted services after suffering component or network failures. Typical high-availability models, such as a typical active-standby redundant deployment model, where an active node is responsible in delivering communication services while the standby node is ready to take over the serving responsibility in case the active node fails, cannot achieve high-availability for active contacts and agents in a contact center system. For a higher degree of service survivability, it is also desirable to have more than one standby node in the system so that the service can continue even after multiple consecutive failures.

In a system that has several nodes where only one of which at any given time should function as the active node while the others function as standby nodes, it is advantageous to have an automatic mechanism that, among other things, enables the nodes to determine which one will be the active node.

Accordingly, in one aspect there is provided a method for fault recovery in a communication system comprising an active node and a first standby node. The method is performed by a first arbiter running on a first node of a communication system, the communication system further comprising a second node and a second arbiter running on the second node.

In one embodiment, the process includes: transmitting to the second arbiter an are you active message; receiving a response message transmitted by the second arbiter, the response message being responsive to the are you active message; and, after receiving the response, determining the first node to be a standby node.

In another embodiment, the process includes: transmitting to the second arbiter a first are you active message; detecting an expiration of a timer prior to receiving any response to the are you active message; and, after detecting the expiration of the timer, determining whether or not to treat the first node as an active node.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

### BRIEF DESCRIPTION OF THE DRAWINGS

The accompanying drawings, which are incorporated herein and form part of the specification, illustrate various embodiments.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 illustrates a pairing node of a contact center according to an embodiment 4

FIG. 3A illustrates a set of nodes of a communication system.

FIG. 3B illustrates an example daisy-chain node configuration.

FIG. 3C illustrates a set of nodes of a communication system.

FIG. 3D illustrates a set of nodes of a communication system.

FIG. 4 is a flowchart illustrating a process according to an embodiment.

FIG. 5 is a flowchart illustrating a process according to an embodiment.

FIG. 6A is a flowchart illustrating a process according to an embodiment.

FIG. 6B is a flowchart illustrating a process according to an embodiment.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a flowchart illustrating a process according to an embodiment.

FIG. 11 is a flowchart illustrating a process according to an embodiment.

FIG. 12 is a flowchart illustrating a process according to an embodiment.

FIG. 13 is a block diagram of a node according to an embodiment.

FIG. 14 illustrates a process according to an embodiment.

### DETAILED DESCRIPTION

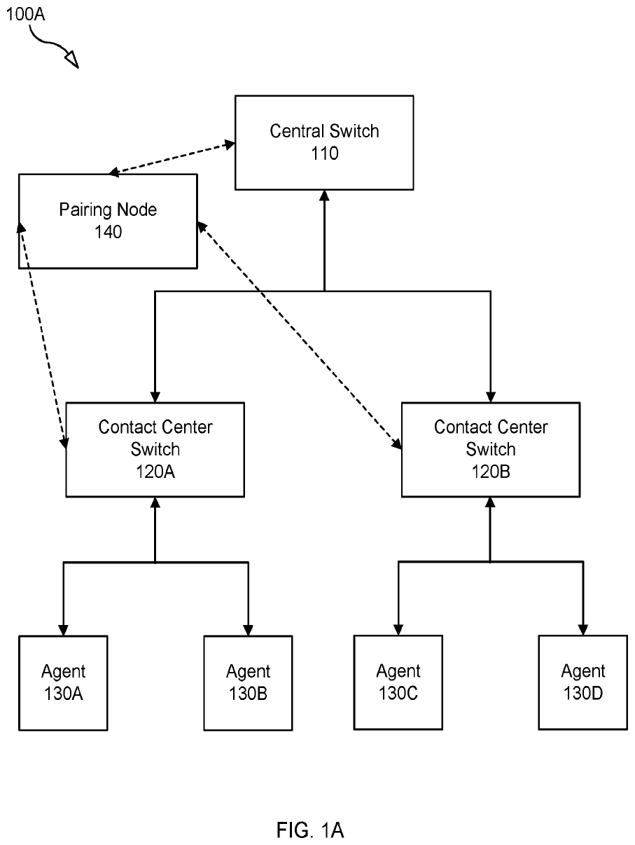

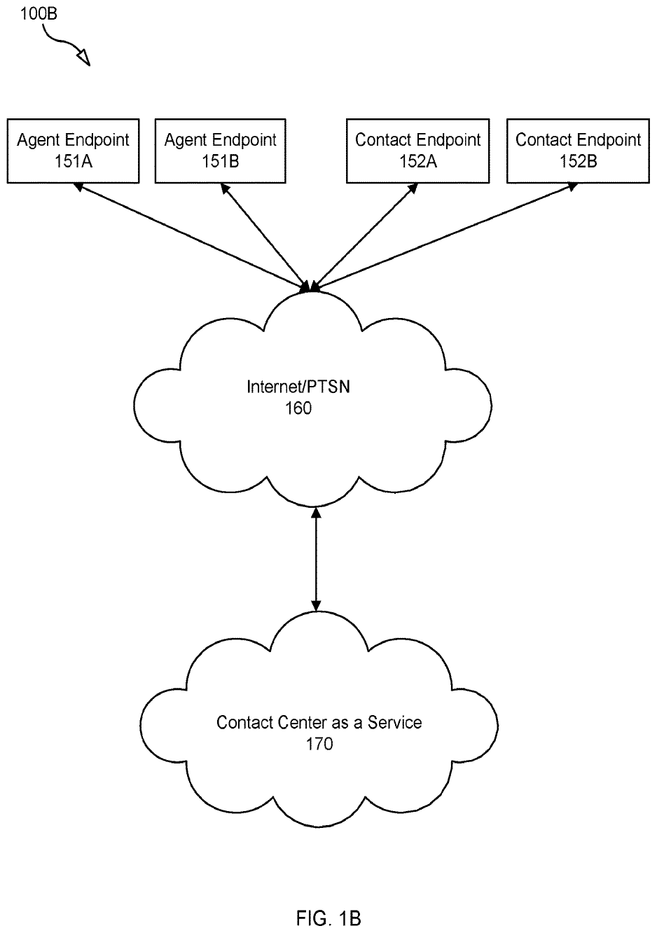

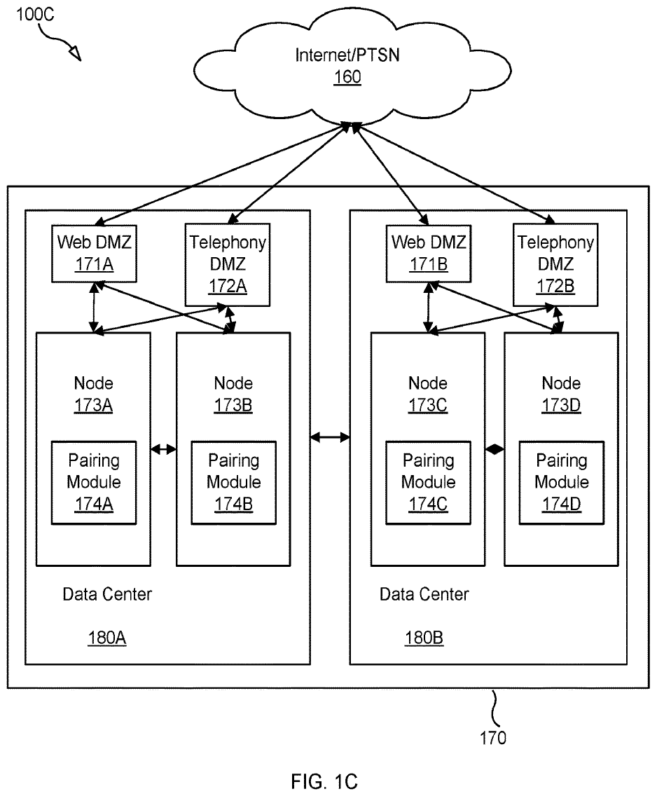

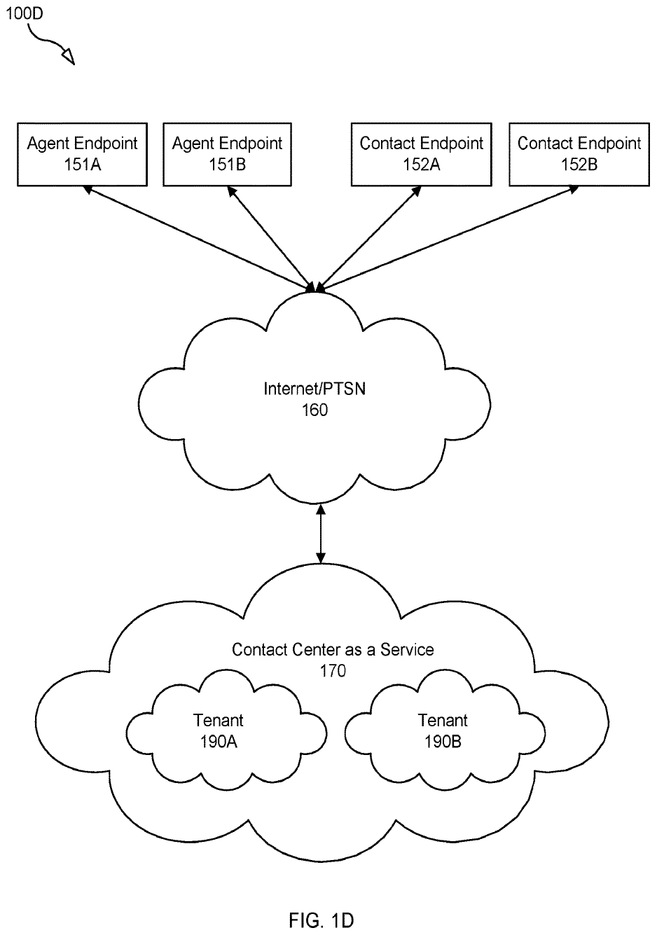

FIG. 1A illustrates an example communication system 100. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100. If more than one contact center is part of the communication system 100, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or IC) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine.

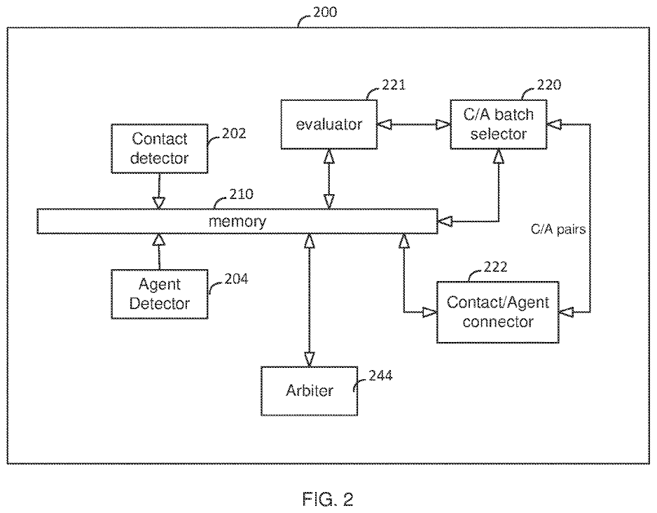

FIG. 2 illustrates an example pairing node 200 according to one embodiment (that is, for example, L3 pairing node 140 of FIG. 1A, or nodes 173A, 173B, 173C, 173D may be implemented using pairing node 200). In the embodiment shown, pairing node 200 includes a memory 210 (e.g., random access memory RAM) such as dynamic RAM (DRAM) or static RAM (SRAM)) for storing contact center information that identifies: (i) a set of contact identifiers (IDs) associated with contacts available for pairing (i.e., contacts waiting to be connected to an agent) and (ii) a set of agent IDs associated with agents available for pairing. In some embodiments, the contact center information includes: i) for each contact ID, metadata for the contact associated with the contact ID (this metadata may include state information indicating whether the contact is available (i.e., waiting to be paired), a score assigned to the contact and/or information about the contact) and ii) for each agent ID, metadata for the agent associated with the agent ID (this metadata may include state information indicating whether the agent is available, a score assigned to the agent and/or information about the agent).

Exemplary information about the contacts and/or agents that may be stored in memory 210 and is associated with the contact ID or agent ID includes: attributes, arrival time, hold time or other duration data, estimated wait time, historical contact-agent interaction data, agent percentiles, contact percentiles, a state (e.g., ‘available’ when a contact or agent is waiting for a pairing, ‘abandoned’ when a contact disconnects from the contact center, ‘connected’ when a contact is connected to an agent or an agent is connected to a contact, ‘completed’ when a contact has completed an interaction with an agent, ‘unavailable’ when an agent disconnects from the contact center) and patterns associated with the agents and/or contacts.

Pairing node 200 also includes several modules (software and/or hardware components) (e.g., microservices) including a contact detector 202 and an agent detector 204. Contact detector 202 is operable to detect an available contact (e.g., contact detector 202 may be in communication with a switch that signals contact detector 202 whenever a new contact calls the contact center) and, in immediate response to detecting the available contact, store in memory 210 at least a contact ID associated with the detected contact (the metadata described above may also be stored in association with the contact ID). Similarly, agent detector 204 is operable to detect when an agent becomes available and, in immediate response to detecting the agent becoming available, store in memory 210 at least an agent identifier uniquely associated with the detected agent (metadata pertaining to the identified agent may also be stored in association with the agent ID). In this way, as soon as a contact/agent becomes available, memory 210 will be updated to include the corresponding contact/agent identifier and state information indicating that the contact/agent is available. Hence, at any given point in time, memory 210 will contain a set of zero or more contact identifiers where each is associated with a different contact waiting to be connected to an agent, and a set of zero or more agent identifiers where each is associated with a different available agent.

Pairing node 200 further includes other modules (e.g., microservices) including: (i) a contact/agent (C/A) batch selector 220 that functions to identify (e.g., based on the state information) sets of available contacts and agents for pairing, and provide state updates (i.e., modify the state information) for contacts and agents once the contacts and agents are selected for pairing and (ii) a C/A pairing evaluator 221 that functions to evaluate information associated with available contacts and information associated with available agents in order to propose contact-agent pairings. As shown in FIG. 2, C/A batch selector 220 is in communication with memory 210, and, thereby, can read from memory 210 the contact center information stored therein (e.g., a set of contact IDs where each contact ID identifies an available contact and a set of agent IDs where each agent ID identifies an available agent). In one embodiment, C/A batch selector 220 is configured to occasionally (e.g., periodically) read memory 210 to obtain a list of available contacts and available agents based on a state associated with the agents and contacts listed in the memory 210. Further, the C/A batch selector 220 is in contact with a C/A pairing evaluator 221, and, after obtaining a list of available contacts and available agents, the C/A batch selector 220 may send the list to the C/A pairing evaluator 221 (e.g., sending contact IDs and agent IDs to the C/A pairing evaluator 221).

After the C/A pairing evaluator 221 receives a set of contact IDs and agent IDs from the C/A batch selector 220, the C/A pairing evaluator 221 may read from memory 210 further information about the received contact IDs and agent IDs. The C/A pairing evaluator 221 uses the read information in order to identify and propose agent-contact pairings for the received contact IDs and agent IDs based on a pairing strategy, which, depending on the pairing strategy used and the available contacts and agents, may result in no contact/agent pairings, a single contact/agent pairing, or a plurality of contact agent pairings.

Upon identifying contact/agent pairing(s), the C/A pairing evaluator 221 sends the set of contact/agent pairing(s) to the batch selector 220. The C/A batch selector 220 provides the set of contact/agent pairing(s) to a contact/agent connector 222 (e.g., if the contact associated with contact ID C12 is paired with the agent associated with the agent ID A7, then C/A batch selector 220 provides these contact/agent IDs to contact/agent connector 222). If the pairing process results in one or more contact/agent pairings, then, for each contact/agent pairing, C/A batch selector 220 will transmits an updated state associated with each contact ID and each agent ID in the one or more contact/agent pairings to memory 210, which is then associated with each contact ID and agent ID. Thereby, memory 210 retains the contact IDs and agent IDs for future analysis.

Contact/agent connector 222 functions to connect the identified agent with the paired identified contact. Further, C/A connector 222 transmits an updated state associated with each contact ID and each agent ID in the one or more contact/agent pairings to memory 210, which is then associated with each contact ID and agent TD.

Therefore, in one embodiment, pairing node 200 provides an asynchronous polling process where memory 210 provides a central repository that is read and updated by the contact detector 202, agent detector 204, C/A batch selector 220, C/A pairing evaluator 221, and C/A connector 222. Accordingly, the objects of each agent and contact do not move between the microservices of pairing node 200; instead identifiers associated with the objects are transmitted between the contact detector 202, agent detector 204, memory 210, C/A batch selector 220, C/A pairing evaluator 221, and C/A connector 222. This process conserves bandwidth, processing power, memory associated with each microservice, and is more expedient than conventional event-based pairing nodes.

As noted above, it is advantageous for a communication system, such as, for example, communication systems 100A, 1001B, 100C 100D, to achieve high availability. Accordingly, in the embodiments disclosed herein an active-standby redundant deployment model is employed.

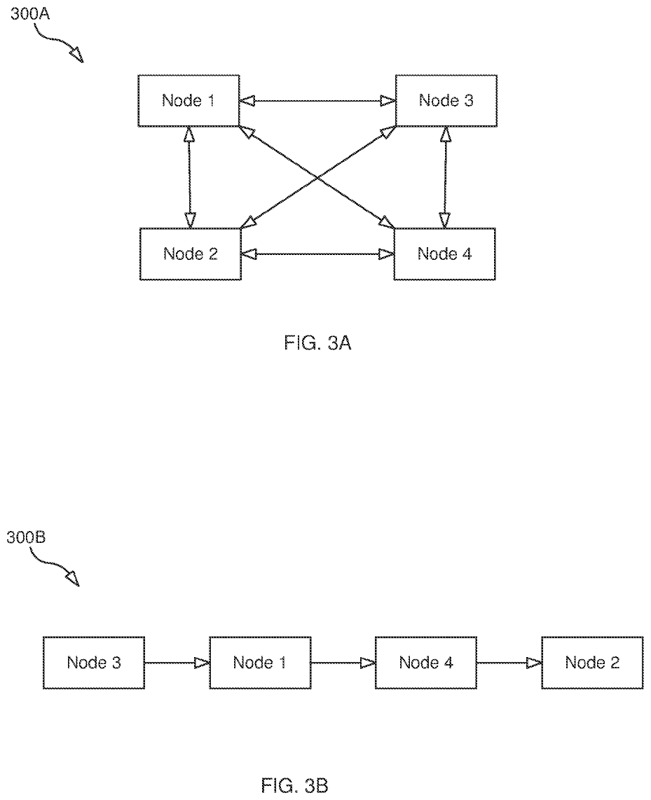

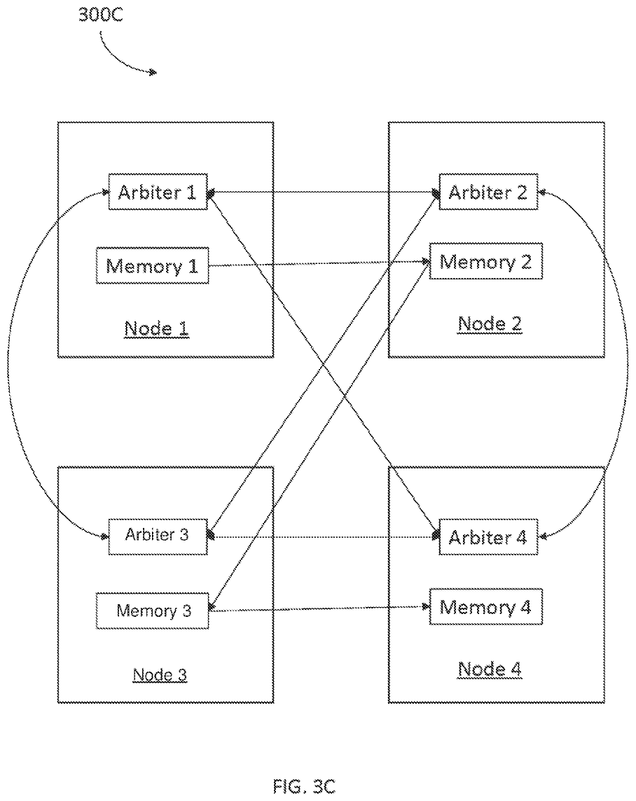

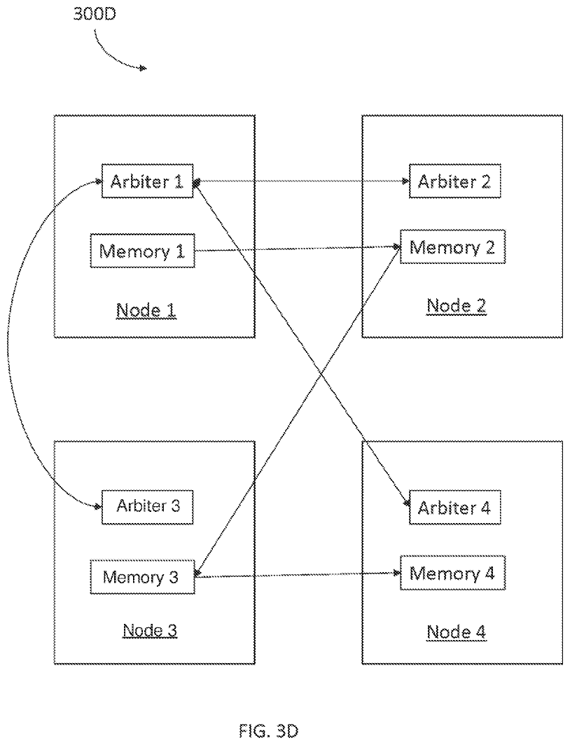

For example, in one possible embodiment, FIG. 3A illustrates a communication system 300A that includes four nodes (node 1, node 2, node 3, and node 4). Each one of these nodes may be an instance of pairing node 200. When there are no faults in the communication system, each one of the four nodes may communicate with each one of the other three nodes, as illustrated in FIG. 3A. In this example, only one of the four nodes is an active node, while the remaining three function as standby nodes in the event of, for example, a failure of the active node. The active node is responsible for delivering communication services (e.g., pairing a contact with an agent as described above) while one or more standby nodes are ready to take over the serving responsibility in case the active node fails.

In a second possible embodiment, the nodes are logically arranged in a linear hierarchy 300B (a.k.a., “daisy-chain topology”), as shown in FIG. 3B, wherein the node on the far left (Node 3) is the active node, the node immediately to the right of the active node is the first standby node (Node 1 in this example), the node immediately to the right of the first standby node is the second standby node, and the node immediately to the right of the second standby node is the third standby node. In the daisy-chain topology, the first standby node becomes the new active node if the current active node fails, the second standby node becomes the new active node if the current active node fails and the first standby node fails, and the third standby node becomes the new active node if the current active node fails and both the first and second standby nodes fail. Such a logical configuration is exemplary as the communication system can have any number of standby nodes. Further, the linear hierarchy 300B of FIG. 3B may be more efficient and reduce a computational load of the active node as compared to FIG. 3A.

Further, in one embodiment, the memory modules of each node are arranged in a linear hierarchy, while an ‘arbiter’ module of each node is arranged in a mesh topology, as shown in FIG. 3C, in communications system 300C. In a first example of a mesh topology, each arbiter may be configured to communicate with each other arbiter, regardless of which node is active.

In a second example of a star topology as shown in FIG. 3D, in communications system 300D, the arbiter of the active node may be configured to communicate with each arbiter of any passive nodes; but the arbiters of passive nodes may not be configured to communicate with arbiters of other passive nodes. For example, when Node 1 is the active node, Arbiter 1 may be in a star configuration with each other arbiter, where Arbiter 1 is configured to communicate directly with Arbiter 2, Arbiter 3, and Arbiter 4. That is, when Node 1 is the active node, Arbiter 2 will not communicate with Arbiter 3 or Arbiter 4, Arbiter 3 will not communicate with Arbiter 2 or Arbiter 4, and Arbiter 4 will not communicate with Arbiter 2 or Arbiter 3. Accordingly, this second example of a star configuration for communication among the arbiters 1, 2, 3, and 4 may be more efficient and reduce a computational load of each passive arbiter. In FIG. 3D, syncing between the memory modules of the nodes may occur according to a linear topology.

In order for a standby node (e.g., Node 1) to successfully and quickly take over the serving responsibility, the standby node needs to maintain in its memory (e.g., memory 210 of node 200) a copy of certain service information stored in the memory of the active node, such as, for example contact attributes, agent attributes, etc. This service information is usually highly dynamic (e.g., changes frequently) and of large volume, particularly in a large scale communication system. Therefore, a data replication mechanism from the memory of the active node to the memory of the standby node(s) is required in order to implement such a high availability communication system.

In one embodiment, the data replication mechanism typically includes the following steps: 1) when the active node performs an action, the active node stores in its service information storage (e.g., a database and/or memory 210 of the active node) an information block resulting from the action; 2) the active node sends a copy of the information block to a standby node; and 3) when the standby receives the information block, it updates its local copy of the service information (e.g., in a service information storage of the passive node, a database, and/or memory 210 of the passive node) accordingly.

Additionally, when multiple standby nodes are configured in the system, such data replication may be implemented using a star topology or a daisy chain topology. In a star topology, the active node “pushes” out the service information updates to all the standby nodes configured in the system, so that every passive node has an updated service information storage (e.g., a database and/or memory 210 of the active node).

In an embodiment that uses the daisy-chain topology discussed above, the active node may only provide the data update to the first standby node when the active node is updating service information storage (e.g., a database and/or memory 210) of the passive node. In this embodiment, the first standby node then propagates the update to the second standby node, the second standby propagates the update to the third standby node, etc.

That is, the active node will form the head of the daisy-chain 300 and will only send information update messages to the standby node that is logically “directly” connected to the active node (i.e., node 3 in this example). Every time standby node 1 receives from the active node an information update message (e.g., updated service information or action identifier that enables node 1 to generate the updated service information, as described below), node 1 will update its own local copy of the service information and also forward (relay) the information update to node 4, which is the “next” standby node in the daisy chain after node 1. Similarly, standby node 4 will perform the same local-update-then-forward operation so that the same service information update will be propagated down the daisy-chain until it reaches the end of the daisy-chain (node 2 in this example). An advantage of this daisy-chain topology is that the active node only needs to send an information update message to one standby node regardless how many standby nodes have been configured in the system.

Another advantage is that the daisy-chain topology makes re-configuration (e.g., scale up or scale down) of the high availability system extremely efficient during operation. For example, assuming that a user decides to scale-up its high availability capability by adding a new standby node during operation, with the daisy-chain topology, the user can simply add the new standby node to the end of the daisy-chain topology or insert the new standby node in the middle of the daisy-chain topology without requiring a heavy-bandwidth change from the active node to newly sync with another standby node. Similarly, individual active or standby nodes can be taken offline temporarily for maintenance and reinserted into the system without any downtime in the contact center system. In conventional star topologies, the active node will restart, or require a software update, when reconfiguring the topology; if used in a contact center, the contact center would need to be offline. A daisy chain topology allows reconfiguration of the topology to occur while a contact center is online.

In another embodiment, in addition to or instead of employing the daisy-chain propagation technique described above, an “action synchronization” mechanism may be employed in order to synchronize the memory modules of multiple nodes. With action synchronization, instead of the active node sending to a standby node an information update message comprising an information block that was generated based on the active node performing an action (i.e., a process that includes one more steps), the active node sends an information update message comprising an action identifier identifying the action. Upon receiving the information update message, the standby node performs the identified action, resulting in the exact same changes to its local copy of the service information (i.e., information block), thus achieving the same effect as the traditional data replication.

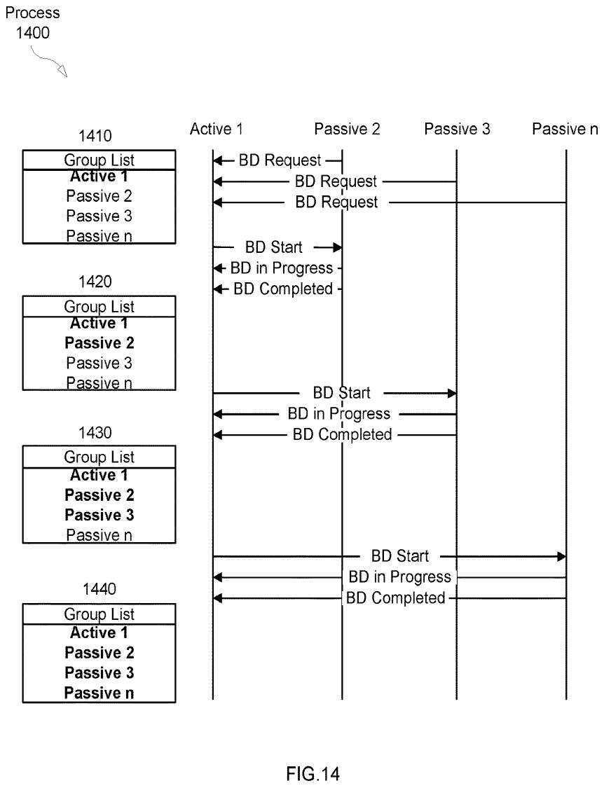

In some embodiments, before the action synchronization approach can be used, the memory of the standby node needs to be synchronized with the memory of the active node so that the standby node has the same service information as the active node (e.g., a “brain dump”, and as further discussed below regarding FIG. 14). Once the standby node is synchronized with the active node via the presently-disclosed “brain dump” method, the active node can begin using the application replication approach. Accordingly, as an example, assume that the active node has created 1000 agent objects and 50 call objects. In this scenario, the active node may first provide to the standby node instructions to create all 1000 agent objects and all 50 call objects with all the same parameters as currently existing on the active node, so that the memory of the standby node will be synchronized with the memory of the active node. After this “brain dump” is completed, if the active node performs an action using a particular set of parameters and the performance of this action results in a new call object, the active node can replicate its data to the standby node by merely sending to the standby node the action identifier and the set of parameters, which will then trigger the standby node to perform the identified action using the set of parameters, which will result in the standby node creating a new call object in its memory, which is identical to the call object created by the active node in the memory of the active node. In this way, the memory of the standby node can stay synchronized with the memory of the active node.

An advantage of the action synchronization approach is that it uses less resources than the traditional approach because less data is sent out from the active node. The information update message, which identifies the action, is much smaller than the data changes (information block) resulting from the action. For example, an information update message that identifies the action “create new call” can be conveyed with a message (e.g., 12 bytes), while the new call object resulting from this action can have a relatively much larger size (e.g., several kilobytes (KB)). As a result, for the same system scale and load level, the amount of synchronization traffic the active node needs to send to a standby node can potentially be reduced significantly using action synchronization. This reduction in traffic can help the system scalability greatly since it saves both CPU cycles and network bandwidth on the active node.

Another advantage is that, in comparison to conventional active-standby systems that use information block data transfers (and which take seconds, or tens of seconds, for the standby node to receive updates from the active node), the information update message, which identifies the action, can be transmitted from the active node to the standby node much faster (e.g., on the magnitude of nanoseconds or microseconds). Further, the action synchronization approach is also faster because the information update message can be transmitted from the active node to the passive node while the active node itself is still processing the information update message. Therefore, this is unlike in a conventional system, where the standby node must first wait for the active node to process the action, create the new information state, and send the new information state to the standby node. In this way, the standby node can receive and even begin processing the action and updating its own memory/state information before the active node completes. This is additionally beneficial if the health of the active node begins to degrade; the standby node may have an accurate memory/state information even if the memory of the active node has a failure when performing the action.

Another advantage is that the action synchronization approach reduces the chance of data corruption on the standby node due to network problems over the sync traffic such as reconnections and data losses. In order to prevent data corruption (e.g., partial data update), traditional data replication usually needs to employ complicated data integrity protection such as cyclic-redundancy-check (CRC), Forward Error Correction (FEC) coding to help detect and recovery from sync traffic data loss. With action synchronization, this becomes much less an issue because the action identifiers sent from the active node may have built-in semantics and their data integrity can be easily verified by the standby node, without needing any additional data integrity protection. If an incomplete or compromised action identifier is received, the standby node will automatically find the action identifier inapplicable and will discard it. This may result in a small out-of-sync situation for the involved object, but will not cause data corruption on the standby node. The system is highly fault tolerant, so if a standby node has slightly outdated state information for a contact object or agent object, the object is still easily recoverable by the standby node, if needed. Therefore, the present disclosure does not require a “brain dump” each time there is an imperfect action ID.

As noted in the Summary section above, in a system that has several nodes where, at any given time, only one of which should function as the active node while the others function as standby nodes, it is advantageous to have an automatic mechanism that, among other things, enables the nodes to determine which one will be the active node as well as determine the priority of each standby node (e.g., the position of each standby node in the daisy-chain topology). To this end, as shown in FIG. 2, each node may have an arbiter module 244 (or “arbiter 244” for short). The arbiter module has low demands on the node, and therefore may be in a mesh or star communication topology with other arbiters, as discussed above regarding FIG. 3C, even while data replication/action synchronization techniques are performed in a daisy-chain topology (see also, FIG. 3C).

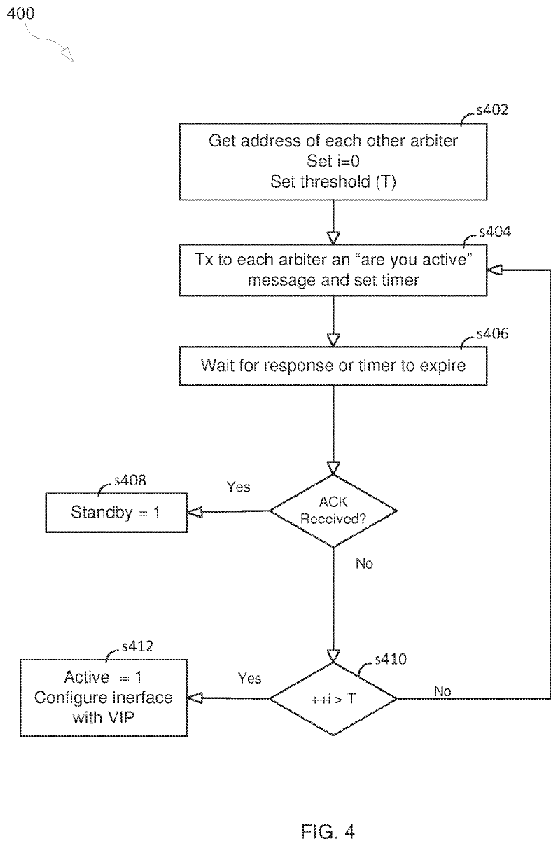

FIG. 4 is a flow chart illustrating a process 400, according to an embodiment, that is performed by each arbiter 244 for determining whether the node on which the arbiter is running should be the active node or one of the standby nodes. Process 400 may begin in step s402.

Step s402 comprises the arbiter obtaining (e.g., from a configuration file) the address of each other configured arbiter (e.g., an IP address assigned to an interface of the node on which the other arbiter is running). For example, before process 400 is performed, each configured arbiter is provided with a configuration file that lists all of the configured arbiters, their corresponding IP address, and a corresponding priority value. Step s402 also comprises the arbiter initializing a counter (e.g., setting i=0) and setting a threshold value (T). For example, the threshold value may be 100 ms, 200 ms, 250 ms, 300 ms, 500 ms, 1 second, 2 seconds, etc. In some embodiments, a low priority value represents a high priority. Hence, an arbiter with a priority value of 0 has a higher priority than an arbiter with a priority of 1.

Step s404 comprises the arbiter transmitting to each other arbiter an “are you active message” and setting a timer to expire after some amount of time has elapsed. The “are you active message” may be an application layer message or a transport layer control message (e.g., a Transmission Control Protocol (TPC) Synchronization (SYN) message).

Step s406 comprises the arbiter waiting for a positive acknowledgement (ACK) or the timer to expire. If an ACK is received, process 400 proceeds to step s408 where the arbiter determines that it is one of the standby arbiters (e.g., the arbiter determines that the node on which it is running is a standby node). If the timer expires before any ACK is received, process 400 proceeds to step s410.

Step s410 comprises the arbiter incrementing the counter by 1 (i.e., ++i) and then comparing the counter to T. If the counter is greater than T, then the process proceeds to step s412, otherwise it proceeds back to step s404. Step s412 comprises the arbiter determining that it is the active arbiter (e.g., the arbiter determines that the node on which it is running is the active node). In some embodiments, step s412 also comprises the arbiter assigning a virtual IP (VIP) address to a network interface of the node on which the arbiter is running. Additionally, in embodiments where there is a router or switch on the same network as the as the active arbiter, the active arbiter may cause the router/switch to update its Address Resolution Protocol (ARP) cache to so that the ARP cache will associate the VIP address with the Media Access Control (MAC) address of the network interface. In this way, IP protocol data units (PDUs) addressed to the VIP address will be sent by the switch/router to the node on which the active arbiter is running.

In some embodiments, prior to performing process 400, the arbiter must verify that all of the critical modules are up-and-running on the same node on which the arbiter is running. In one embodiment this is accomplished by providing the arbiter with a list of the critical modules (e.g., a list of module IDs) and having each critical module insert into a shared message queue stored in memory 210 an “I'm ready” message; optionally, the “I'm ready” message further contains the module ID for the module. The arbiter is able to read the messages stored in the shared message queue. Thus, the arbiter is able to determine whether each critical module has inserted its “I'm ready” message into the shared message queue. In one embodiment, the arbiter immediately performs process 400 as a result of determining that each critical module has inserted its “I'm ready” message into the shared message queue.

Further, in some embodiments, the arbiter is configured to receive heartbeat messages from all the modules in a node (e.g., as shown in FIG. 2), including heartbeat messages from both critical and non-critical modules. Accordingly, the arbiter may determine when a module has missed sending heartbeat message. Based on the arbiter determining that a module has missed sending a heartbeat message, the arbiter may determine (1) whether the module itself should restart, (2) whether the arbiter should ignore the missed message and (for example, the arbiter may wait for a threshold amount of time before taking a different action), or (3) whether the arbiter should force its associated node to restart (for example, if the module is critical). Therefore, if the arbiter forces its associated node to restart, the node may rejoin the topology via process 400.

Further, if the arbiter determined that it is on the active node after performing process 400, the arbiter may establish a UDP port with each other node in the topology. Passive nodes may receive broadcasts at their UDP ports, but may not retain, analyze, or listen to said broadcasts while they are passive.

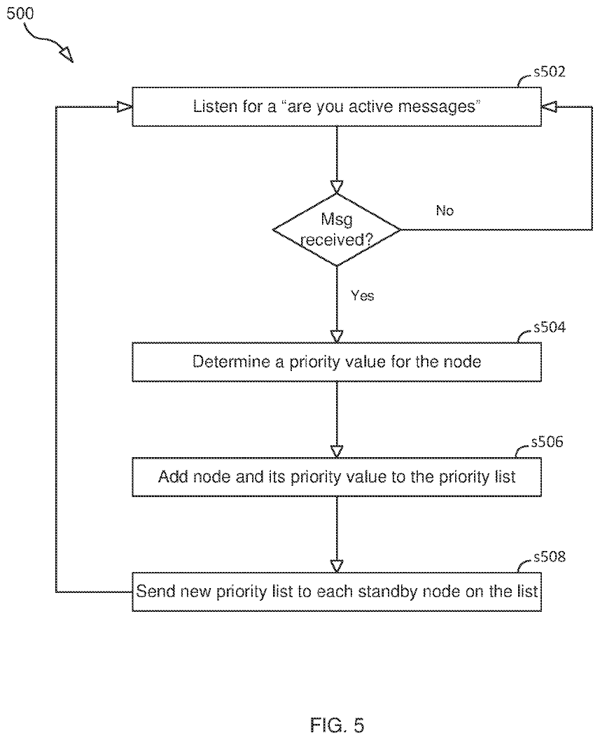

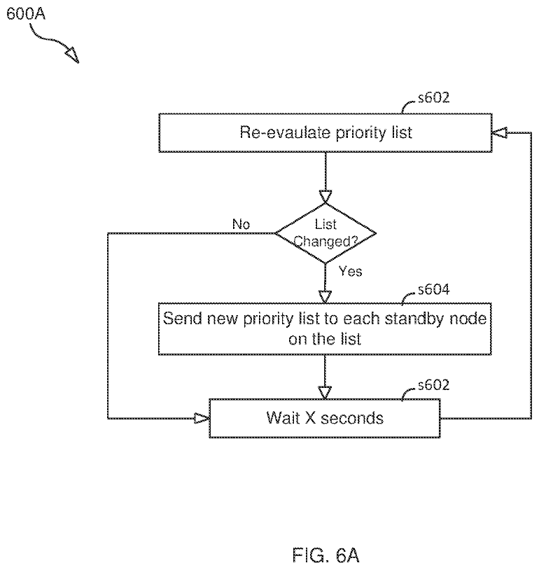

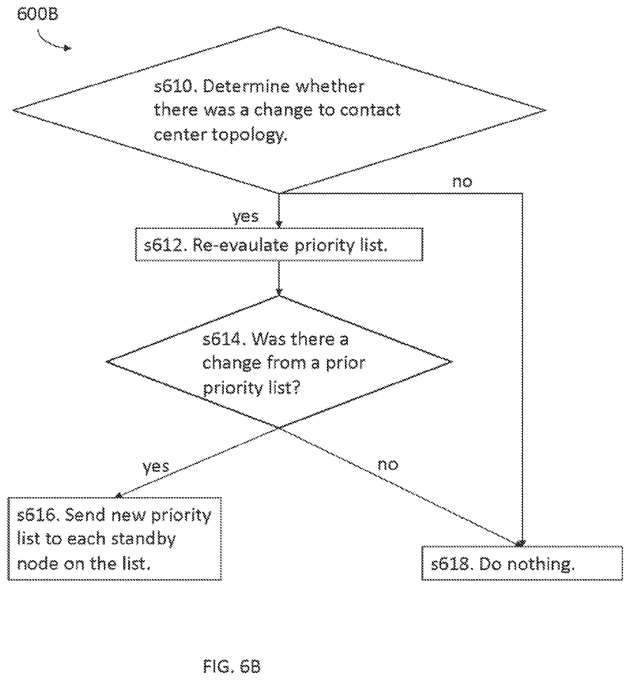

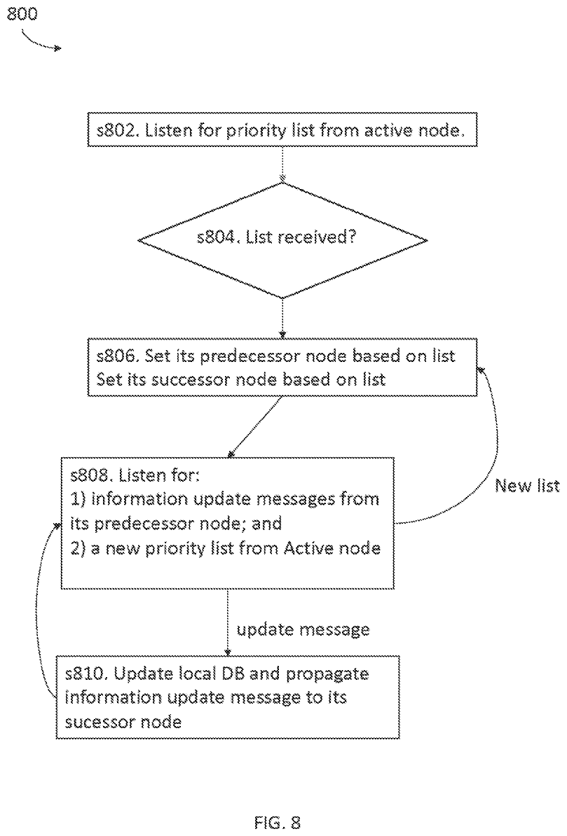

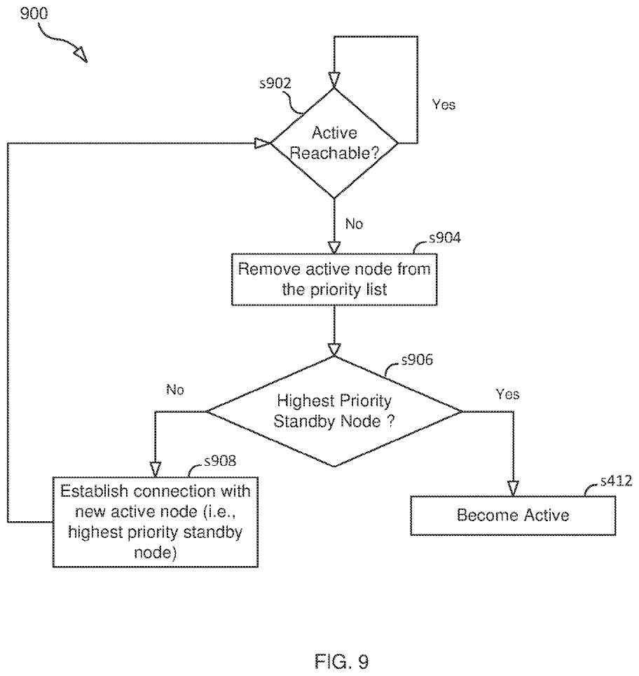

In some embodiments, after performing process 400 the arbiter will perform process 500 (see FIG. 5) and process 600 (see FIG. 6) provided that the arbiter determined that it is on the active node, otherwise the arbiter is on a standby node and performs process 800 (see FIG. 8) and process 900 (see FIG. 9).

FIG. 5 is a flow chart illustrating a process 500, according to an embodiment, that may be performed by each active arbiter. Process 500 may begin in step s502.

Step s502 comprises the arbiter listening for “are you active” messages. In one embodiment, this comprises the arbiter creating a socket and binding its IP address and port number to the socket. If an “are you active” message is received, the process proceeds to step s504.

Step s504 comprises the arbiter determining a priority value for the node from which the message was sent.

Step s506 comprises the arbiter adding the node and its priority value to a node priority list. For example, the table below illustrates an example priority list:

TABLE 1
Example Node Priority List

| Node ID | Priority Value |
|---|---|
| Node 3 | 0 |
| Node 1 | 1 |
| Node 4 | 2 |
| Node 2 | 3 |

In the example above, the active node is Node 3 and Nodes 1, 2, and 4 are all standby nodes. Hence, the arbiter that is performing process 500 is running on Node 3.

Step s508 comprises the arbiter transmitting the priority list to each standby node on the priority list. In this way, each standby node will be able to determine its position in the linear hierarchy.

FIG. 6A is a flow chart illustrating a process 600A, according to an embodiment, that may be performed by each active arbiter. Process 600A may begin in step s602. Step s602 comprises the arbiter re-evaluating the priority list (i.e., changing the priority list when it is determined that a change is needed). If the priority list has changed, the process proceeds to step s604, otherwise it proceeds to step s606. Step s604 comprises the arbiter sending the new priority list to each standby node on the list. In this way, each standby node will be able to determine its new position (if any) in the updated linear hierarchy. Step s606 comprises the arbiter waiting for X seconds, where X is a configurable amount of time (e.g., 30 seconds). After determining that the configured amount of time has elapsed, the arbiter once again performs process 600. In this way, arbiter occasionally (e.g., periodically) re-evaluates the priority list.

FIG. 6B is a flow chart showing an alternative process 600B to process 600A. Wherein process 600A is a periodic re-evaluation of the priority list, process 600B is an event-based re-evaluation of the priority list. Process 600B may begin in step s610 and may be performed by the active arbiter. Step 610 comprises the arbiter determining whether there was a change to contact center topology, such as one or more nodes rebooting, one or more nodes joining the topology, or one or more existing nodes being removed from the topology. If there was a change to the topology, the process proceeds to step s612, otherwise it proceeds to step s618, and the process ends. Step s612 comprises the arbiter re-evaluating the priority list (i.e., changing the priority list when it is determined that a change is needed). Step s614 comprises determining if the priority list has changed. If the priority list has changed, the process proceeds to step s616, otherwise it proceeds to step s618, and the process ends. For example, an event based system such as process 600B may be more computationally efficient than a periodic re-evaluation of the priority list, as in process 600A.

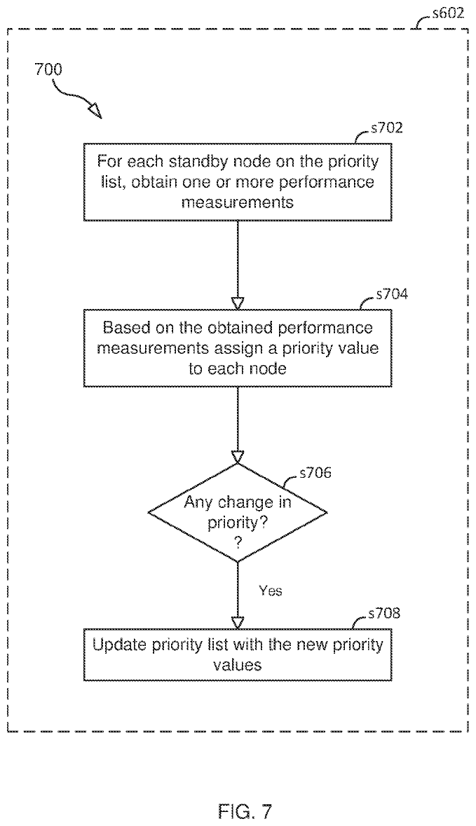

FIG. 7 is a flow chart illustrating a process 700, according to an embodiment, that may be used to perform step s602. Process 700 may begin in step s702. Step s702 comprises the arbiter obtaining a set of one or more performance measurements for each standby node on the priority list. For each standby node, the set of performance measurements for the standby node may include: a latency value, a processor utilization value, a memory utilization value, etc. The latency value, in one embodiment, is an average round-trip-time (RTT) between the active node and the standby node. This average RTT value can be determined using the Internet Control Message Protocol (ICMP). For example, for each standby node on the priority list, the active node sends to the standby node N ICMP echo request messages (a.k.a., “ping” message), where N>0. For each ping message sent, the arbiter records the time it was sent and records the time it received a reply to the ping message. In this way, the arbiter can calculate N RTTs and then can calculate the average of these N RTTs. If the arbiter does not receive a response to any of the ping message sent to a particular standby node, then arbiter may, in some embodiments, remove the standby node from the priority list or set the average RTT value for this standby node to a high value (e.g., 999999999).

Step s704 comprises the arbiter assigning a priority value to each standby node based on the obtained measurement values. For example, assuming that the obtained measurement values consist of an average RTT for each standby node, the arbiter can assign the priority values based on the average RTT values. For instance, the standby node having the smallest RTT value will be assigned a priority of 1, the standby node having the second smallest RTT value will be assigned a priority of 2, the standby node having the third smallest RTT value will be assigned a priority of 3, etc.

Step s706 comprises the arbiter determining whether any of the priority values have changed since the last time it propagated the priority list to each standby node. If priority values have changed, then the process proceeds to step s708.

Step s708 comprises the arbiter updating the priority list with the new priority values (additionally, as described above, if a standby node did not respond to any ping message, then, in some embodiments, the standby node may be removed from the priority list).

FIG. 8 is a flow chart illustrating a process 800, according to an embodiment, that is performed by each standby arbiter. Process 800 may begin in step s802. Step s802 comprises the arbiter listening for a priority list from the active node. For example, in one embodiment, when the standby arbiter sent its “are you active” message to the active arbiter, the standby node initiated and established a TCP connection with the active arbiter, and in step s802, the standby arbiter waits for the active arbiter to send the priority list via the established TCP connection. When the priority list is received, the process proceeds to step s804. Therefore, although the nodes may be logically configured for action synchronization in a daisy-chain topology, the arbiters may be logically configured in a star, or a mesh topology, as discussed herein.

Step s804 comprises the standby arbiter setting its predecessor and successor nodes. The predecessor node is the node immediately to the left of the standby arbiter in the linear hierarchy (“daisy-chain”) and the successor node is the node immediately to the right of the standby arbiter. Using FIG. 3B as an example, when process 800 is performed by the standby arbiter running on Node 4, the priority list received from the active node (Node 3) will indicate that Node 1 is the predecessor node and Node 2 is the successor node.

Step s806 comprises the standby arbiter listening for two things: i) information update messages to synchronize the memory of the standby arbiter with the memory of its predecessor node (e.g., either the data replication or action synchronization discussed herein) transmitted by its predecessor node and ii) a new priority list transmitted by the current active node.

If a new priority list is received, then standby process again performs steps s806, and, if an information update message is received, then the standby arbiter performs steps s810.

Step s810 comprises the standby node updating its local database (e.g., memory 210) based on the content of the information update message. For example, if the information update message comprises an action identifier and a set of parameters values, the standby arbiter causes the standby node on which it is running to perform the identified action using the set of parameter values, which will cause an update to information stored in the local database of the standby node. Assuming no faults, after performing the action, the local database on the standby node should be identical to the local database on the active node. In this way, the standby node will maintain data synchronization with the active node. This is advantageous because if the standby node has to take over for the active node (e.g., due to a network failure or failure of the active node), the standby node will be able to immediately pick-up where the active node left off. Additionally, step s810 comprises the standby arbiter propagating (e.g., forwarding, or relaying) the information update message to its child node so that the child node will maintain data synchronization with the active node.

FIG. 9 is a flow chart illustrating a process 900, according to an embodiment, that is performed by each standby arbiter. Process 900 may begin in step s902. Step s902 comprises the standby arbiter determining whether or not the active arbiter is reachable. If the active arbiter is not reachable, process 900 proceeds to step s904.

For example, step s602 includes the active arbiter periodically sending a heartbeat message to the standby arbiter via the TCP connection, and, if no such heartbeat message is received within a certain amount of time from when the heartbeat message was expected from the last time a heartbeat message was received, the standby arbiter can declare the active arbiter as no longer being reachable. As yet another example, the standby arbiter is configured to periodically send the heartbeat message to the active arbiter via the TCP connection, and, if no heartbeat response message from the active arbiter is received within a certain amount of time, the standby arbiter can declare the active arbiter as no longer being reachable. That is, the active arbiter may have bidirectional communication with every standby node so that every standby node may determine whether or not the active arbiter is reachable according to step s902.

Step s904 comprises the standby arbiter removing the active arbiter from the most recent priority list.

Step s906 comprises the standby arbiter determines whether it was next in line to be the active arbiter (i.e., whether the priority list indicates that it has the highest priority). If the standby arbiter determines whether it was next in line to be the active arbiter, then the standby arbiter performs step s412 (described above) as well as performing process 500 and 600 because it is now the active arbiter, otherwise process 900 may go to step s908.

Step s908 comprises the standby arbiter establishing (e.g., initiating or accepting) a connection (e.g., a TCP connection) with the standby node that was next in line to be the active arbiter (i.e., now the new active arbiter). After steps s908, process 900 may return to step s902.

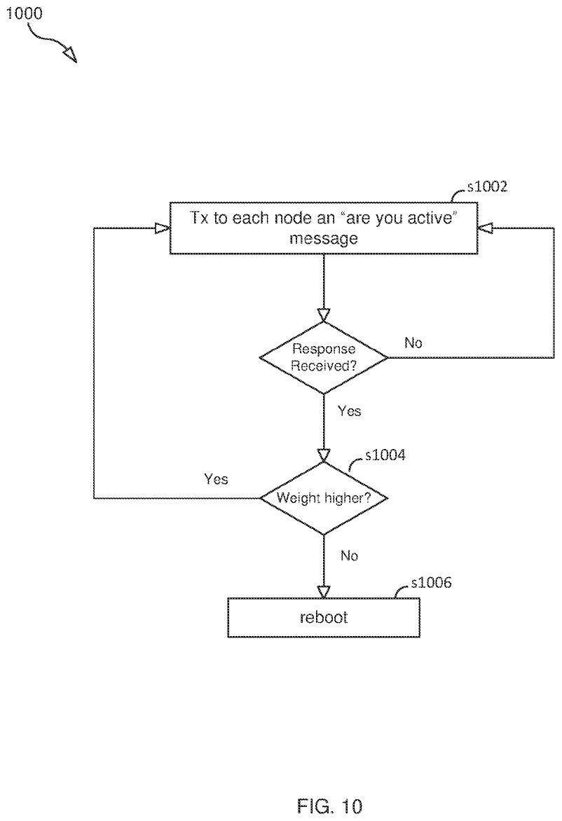

In some situations it may be possible for two arbiters to declare themselves as the active arbiter. For example, assume the daisy-chain shown in FIG. 3B and assume Node 1 and Node 2 are in one datacenter (Datacenter-1) and Node 3 and Node 4 are in another datacenter (Datacenter-2) and further assume that a network fault has occurred such that the none of the nodes in Datacenter-1 can reach any of the nodes in Datacenter-2 and vice-versa. In this scenario, Node 3 will remain “active” whereas Node 1 will transmission from standby to active. Hence, there will be two active arbiters at the same. To recover from such a situation once the network fault is resolved and the nodes in Datacenter-1 may now reach the nodes in Datacenter-2 and vice-versa, each active arbiter may perform process 1000 (see FIG. 10).

Process 1000 may begin in step s1002. Step s1002 comprises the active arbiter sending a weight value message to all nodes in its topology (e.g., the nodes weight as received from its configuration file) at a UDP port, and the active arbiter may be listening for other messages at the UDP port. If another active arbiter receives the message, the second active arbiter transmits a response message that comprises a weight value that was assigned to the second active arbiter. For example, the second active arbiter may also be sending a weight value message at the UDP port, which the first active arbiter may receive. The active arbiter that receives the message, e.g., the first active arbiter, determines whether the weight value assigned to it is greater than the weight value included in the response message (see steps s1004). If the weight value assigned to it is not greater than the weight value included in the response message, then the active arbiter forces the node on which it is running to perform a reboot.

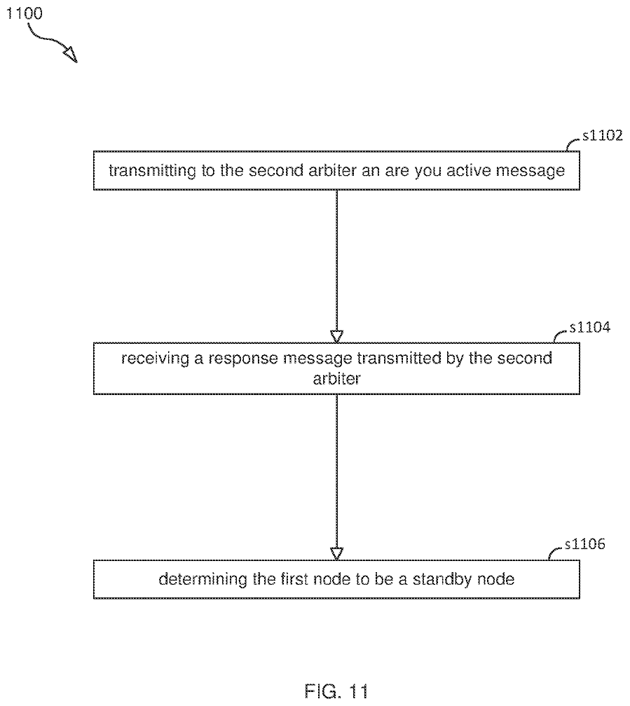

FIG. 11 is a flow chart illustrating a process 1100, according to an embodiment, performed by a first arbiter running on a first node (e.g., Node 1) of a communication system comprising a second node (e.g., Node 2) and a second arbiter running on the second node. For example, process 1100 is an enrollment process. Process 1100A may begin in step s1102. Step s1102 comprises transmitting to the second arbiter an “are you active” message. Step s1104 comprises receiving a response message transmitted by the second arbiter, the response message being responsive to the “are you active” message. Step s1106 comprises, after receiving the response, determining the first node to be a standby node.

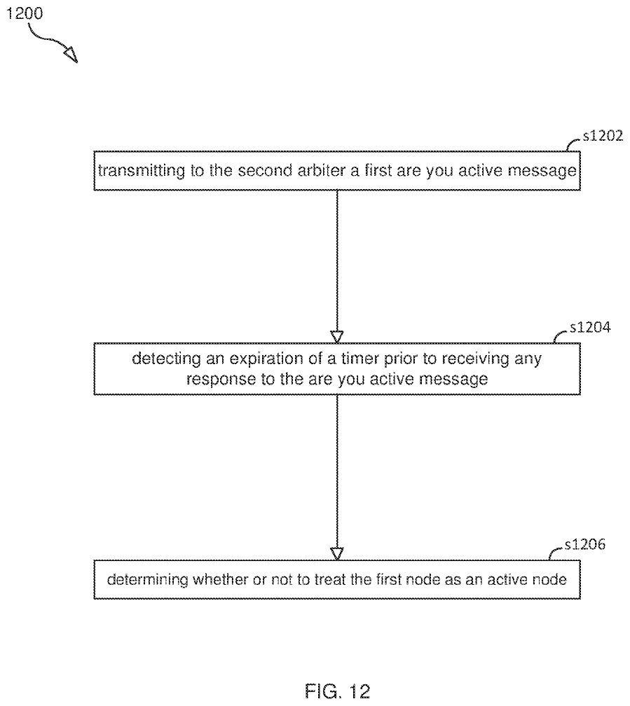

FIG. 12 is a flow chart illustrating a process 1200, according to an embodiment, performed by a first arbiter running on a first node of a communication system comprising a second node and a second arbiter running on the second node. Process 1200 may begin in step s1202. Step s1202 comprises transmitting to the second arbiter a first “are you active” message Step s1204 comprises detecting an expiration of a timer prior to receiving any response to the “are you active” message. Step s1206 comprises after detecting the expiration of the timer, determining whether or not to treat the first node as an active node.

Turning now to FIG. 14, an exemplary process 1400 is shown, according to some embodiments. Process 1400 begins at step 1410 when one or more passive, or standby nodes send a “brain dump” request message to an active node. Process 1400 shows an exemplary three nodes requesting a “brain dump”, for example, when all nodes joined a node topology at a similar time. A similar process could be followed for any number of nodes.

Step 1420 comprises the active node sending a “permission to start brain dump” instruction message to the passive (e.g., standby) node which has the highest priority. Said first passive node with the highest priority sends a “brain dump start” message to the active node, and said first passive node performs a full memory state synchronization process (e.g., either through data replication or action synchronization) with the active node. Said first passive node then sends a “brain dump complete” message to the active node when the full memory state synchronization process is complete.

After receiving the “brain dump complete” message from said first passive node, step 1430 comprises the active node sending a “permission to start brain dump” instruction message to the passive node which has the next highest priority. Said second passive node sends a “brain dump start” message to the active node, and said second passive node preforms a full memory state synchronization process (e.g., either through data replication or action synchronization) with the first passive node. That is, the active node is not required to provide a full memory state synchronization for any node except for the first standby node having the highest priority. Said second passive node then sends a “brain dump complete” message to the active node when the full memory state synchronization process is complete.

After receiving the “brain dump complete” message from said first passive node, step 1430 comprises the active node sending a “permission to start brain dump” instruction message to the passive node which has the next highest priority. Said second passive node sends a “brain dump start” message to the active node, and said second passive node preforms a full memory state synchronization process (e.g., either through data replication or action synchronization) with the first passive node. That is, the active node is not required to provide a full memory state synchronization for any node except for the first standby node having the highest priority. Said second passive node then sends a “brain dump complete” message to the active node when the full memory state synchronization process is complete.

After receiving the “brain dump complete” message from said second passive node, step 1440 comprises the active node sending a “permission to start brain dump” instruction message to the passive node which has the next highest priority. Said third passive node sends a “brain dump start” message to the active node, and said third passive node preforms a full memory state synchronization process (e.g., either through data replication or action synchronization) with the second passive node. That is, the first passive node is not required to provide a full memory state synchronization for any node except for the second passive node having the highest priority. Said third passive node then sends a “brain dump complete” message to the active node when the full memory state synchronization process is complete.

For example, process 1400 may be performed: when one or more nodes joins a node topology; after a data center becomes unoperational (e.g., data centers 180A, 180B of FIG. 1C); and/or after a node restarts. Process 1400 therefore provides a resource efficient and high-accuracy method to synchronize the memory states of multiple nodes with all nodes having an approximately equal utilization.

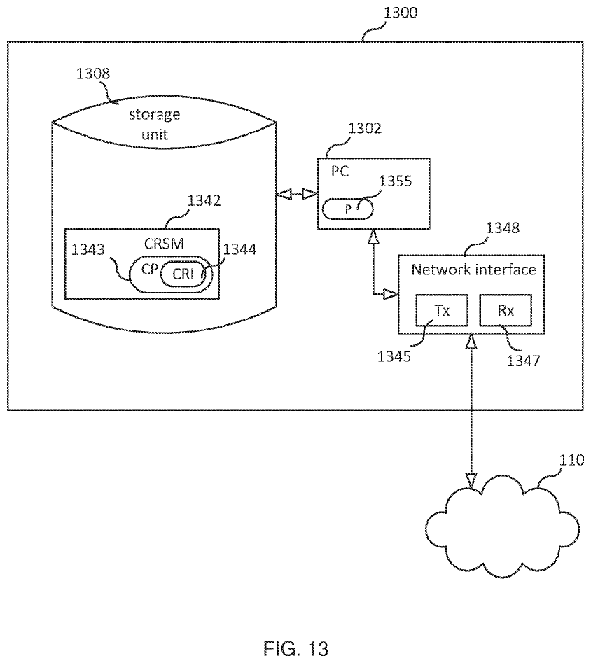

FIG. 13 is a block diagram of a node 1300, according to some embodiments. Node 1300 can be an active node or a standby node. As shown in FIG. 13, node 1300 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., node 1300 may be a distributed computing apparatus); at least one network interface 1349 (e.g., a physical interface or air interface) comprising a transmitter (Tx) 1345 and a receiver (Rx) 1347 for enabling node 1300 to transmit data to and receive data from other nodes connected to a network 110 (e.g., an Internet Protocol (IP) network) to which network interface 1349 is connected (physically or wirelessly) (e.g., network interface 1349 may be coupled to an antenna arrangement comprising one or more antennas for enabling node 1300 to wirelessly transmit/receive data); and a storage unit (a.k.a., “data storage system”) 1309, which may include one or more non-volatile storage devices and/or one or more volatile storage devices. In embodiments where PC 1302 includes a programmable processor, a computer readable storage medium (CRSM) 1342 may be provided. CRSM 1342 may store a computer program (CP) 1343 comprising computer readable instructions (CRI) 1344. CRSM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes node 1300 to perform steps described herein (e.g., steps described herein with reference to the flow charts). In other embodiments, node 1300 may be configured to perform steps described herein without the need for code. That is, for example, PC 1302 may consist merely of one or more ASICs. Hence, the features of the embodiments described herein may be implemented in hardware and/or software.

### Summary of Various Embodiments

A1. A method performed by a first arbiter running on a first node of a communication system comprising a second node and a second arbiter running on the second node, the method comprising transmitting to the second arbiter an are you active message; receiving a response message transmitted by the second arbiter, the response message being responsive to the are you active message; after receiving the response, determining the first node to be a standby node.

A2. The method of embodiment A1, further comprising, after determining the first node to be a standby node, receiving a first priority list from the second arbiter.

A3. The method of embodiment A2, further comprising: determining a first predecessor node based on information in the first priority list; and listening for information update messages from the first predecessor node.

A4. The method of embodiment A3, further comprising: determining a first successor node based on the first priority list; receiving a first update message transmitted by the first predecessor node; and in response to receiving the first update message, transmitting to the first successor node a second update message.

A5. The method of embodiment A4, wherein the first update message has a payload, the second update message has a payload, and the payload of the second update message is the same as the payload of the first update message.

A6. The method of any one of embodiments A2-A5, further comprising: after receiving the first priority list, receiving a second priority list; determining a second predecessor node based on information in the second priority list; listening for information update messages from the second predecessor node; determining a second successor node based on the second priority list, receiving an update message transmitted by the second predecessor node; and in response to receiving the update message transmitting by the second predecessor node, transmitting an update message to the second successor node.

A7. The method of any one of embodiments A1-A6, further comprising: determining that the second arbiter is not reachable; and as a result of determining that the second arbiter is not reachable, determining whether to become an active arbiter.

A8. The method of embodiment A7, further comprising: as a result of determining not to become an active arbiter, establishing a connection with a third arbiter.

A9. The method of embodiment A8, wherein a priority is assigned to the first arbiter, and determining whether to become an active arbiter comprises comparing a priority assigned to the third arbiter to the priority assigned to the first arbiter.

A10. The method of embodiment A8 or A9, wherein establishing a connection with the third arbiter comprising initiating the establishment of a TCP connection with the third arbiter (i.e., transmit TCP SYN message to third arbiter).

B1. A method performed by a first arbiter running on a first node of a communication system comprising a second node and a second arbiter running on the second node, the method comprising transmitting to the second arbiter a first are you active message; detecting an expiration of a timer prior to receiving any response to the are you active message; after detecting the expiration of the timer, determining whether or not to treat the first node as an active node.

B2. The method of embodiment B1, wherein determining whether or not to treat the first node as an active node comprises comparing a priority assigned to the first arbiter to a priority assigned the second arbiter.

B3. The method of embodiment B1, wherein determining whether or not to treat the first node as an active node comprises comparing a counter to a threshold.

B4. The method of embodiment B3, wherein the value of the threshold is set based on a priority assigned to the first arbiter.

B5. The method of any one of embodiments B1-B4, further comprising: after determining whether not to treat the first node as an active node after detecting the expiration of the timer, transmitting to the second arbiter a second are you active message.

B6. The method of any one of embodiments B1-B4, further comprising: determining to treat the first node as the active node; generating (e.g., creating or updating) a priority list; and transmitting the priority list to the second arbiter, wherein generating the priority list comprises determining a priority of the second node, and the priority list indicates the priority of the second node.

B7. The method of embodiment B6, wherein determining the priority of the second node comprising obtaining a set of one or more measurement values for the first node and determining the priority using the set of measurement values.

B8. The method of embodiment B7, wherein the set of measurement values comprises a latency value (e.g., an average RTT value).

B9. The method of embodiment B8, wherein obtaining the latency value comprises transmitting N ping messages to the second node, N>0.

B10. The method of embodiment B7, B8, or B9, wherein the set of measurement values comprises one or both of a processor utilization value or a memory utilization value for the second node.

C1. A computer program 1343 comprising instructions 1344 which when executed by processing circuitry 1302 of a node causes the node to perform the method of any one of the above embodiments.

C2. A carrier containing the computer program of embodiment C1, wherein the carrier is one of an electronic signal, an optical signal, a radio signal, and a computer readable storage medium 1342.

D1. A node 1300 in a communication system, the node being configured to perform the method of any one of embodiments A1-A10 or B1-B10.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first arbiter running on a first node of a communication system comprising a second node and a second arbiter running on the second node, the method comprising:
transmitting to the second arbiter an are you active message;
receiving a response message transmitted by the second arbiter, the response message being responsive to the are you active message; and
after receiving the response, determining the first node to be a standby node.

2. The method of claim 1, further comprising, after determining the first node to be a standby node, receiving a first priority list from the second arbiter.

3. The method of claim 2, further comprising:
determining a first predecessor node based on information in the first priority list; and
listening for information update messages from the first predecessor node.

4. The method of claim 3, further comprising:
determining a first successor node based on the first priority list;
receiving a first update message transmitted by the first predecessor node; and
in response to receiving the first update message, transmitting to the first successor node a second update message.

5. The method of claim 4, wherein
the first update message has a payload,
the second update message has a payload, and
the payload of the second update message is the same as the payload of the first update message.

6. The method of claim 2, further comprising:
after receiving the first priority list, receiving a second priority list;
determining a second predecessor node based on information in the second priority list;
listening for information update messages from the second predecessor node;
determining a second successor node based on the second priority list;
receiving an update message transmitted by the second predecessor node; and
in response to receiving the update message transmitting by the second predecessor node, transmitting an update message to the second successor node.

7. The method of claim 1, further comprising:
determining that the second arbiter is not reachable; and
as a result of determining that the second arbiter is not reachable, determining whether to become an active arbiter.

8. The method of claim 7, further comprising:
as a result of determining not to become an active arbiter, establishing a connection with a third arbiter.

9. The method of claim 8, wherein
a priority is assigned to the first arbiter, and
determining whether to become an active arbiter comprises comparing a priority assigned to the third arbiter to the priority assigned to the first arbiter.

10. The method of claim 8, wherein establishing a connection with the third arbiter comprising initiating the establishment of a TCP connection with the third arbiter (i.e., transmit TCP SYN message to third arbiter).

11. A method performed by a first arbiter running on a first node of a communication system comprising a second node and a second arbiter running on the second node, the method comprising:
transmitting to the second arbiter a first are you active message;
detecting an expiration of a timer prior to receiving any response to the are you active message;
after detecting the expiration of the timer, determining whether or not to treat the first node as an active node.

12. The method of claim 11, wherein determining whether or not to treat the first node as an active node comprises comparing a priority assigned to the first arbiter to a priority assigned the second arbiter.

13. The method of claim 11, wherein determining whether or not to treat the first node as an active node comprises comparing a counter to a threshold.

14. The method of claim 13, wherein the value of the threshold is set based on a priority assigned to the first arbiter.

15. The method of claim 11, further comprising:
after determining whether not to treat the first node as an active node after detecting the expiration of the timer, transmitting to the second arbiter a second are you active message.

16. The method of claim 11, further comprising:
determining to treat the first node as the active node;
generating a priority list; and
transmitting the priority list to the second arbiter, wherein
generating the priority list comprises determining a priority of the second node, and
the priority list indicates the priority of the second node.

17. The method of claim 16, wherein determining the priority of the second node comprising obtaining a set of one or more measurement values for the first node and determining the priority using the set of measurement values.

18. The method of claim 17, wherein
the set of measurement values comprises a latency value, and
obtaining the latency value comprises transmitting N ping messages to the second node, N>0.

19. (canceled)

20. The method of claim 17, wherein the set of measurement values comprises one or both of a processor utilization value or a memory utilization value for the second node.

21. A non-transitory computer readable storage medium storing a computer program comprising instructions for configuring a node comprising processing circuitry for executing the instructions to perform the method of claim 1.

22-23. (canceled)
